(19) United States
(12) Patent Application Publication
(10) Pub. No.: US 2014/0185181 A1
(43) Pub. Date: Jul. 3, 2014

(54) TUNABLE CAPACITOR

(71) Applicant: INDUSTRIAL TECHNOLOGY RESEARCH INSTITUTE, (US)

(72) Inventors: Jyun-Cheng Huang, Hualien County (TW); Chih-Hsiang Ko, Tainan (TW); Tsun-Che Huang, Tainan (TW); Chin-Hung Wang, Hsinchu (TW)

(73) Assignee: INDUSTRIAL TECHNOLOGY RESEARCH INSTITUTE, Hsinchu (TW)

(21) Appl. No.: 13/891,774

(22) Filed: May 10, 2013

(30) Foreign Application Priority Data
Jan. 2, 2013 (TW) 102100017

(51) Int. Cl. H01G 7/00

(52) U.S. Cl. CPC H01G 7/00
USPC 361/281

(57) ABSTRACT

A tunable capacitor includes a substrate, a movable member, a first capacitive plate, a second capacitive plate, a third capacitive plate and a set of electrode plates. The movable member is disposed on the substrate. The movable member is adapted for moving away or toward the substrate to have a first position and a second position, respectively. The first capacitive plate is disposed on the movable member and faces the substrate. The second capacitive plate and the third capacitive plate are disposed on the substrate and face the first capacitive plate. The set of electrode plates, disposed on the substrate, faces the at least one movable member. The set of electrode plates, driven by an electrical voltage, generates electrostatic force causing the movable member to be drawn from the first position to the second position thereof to correspondingly adjust capacitance between the capacitive plates.

### CROSS-REFERENCE TO RELATED APPLICATIONS

This non-provisional application claims priority under 35 U.S.C. §119(a) on Patent Application No(s). 102100017 filed in Taiwan, R.O.C. on Jan. 2, 2013, the entire contents of which are hereby incorporated by reference.

### TECHNICAL FIELD

The disclosure relates to a tunable capacitor.

### BACKGROUND

Tunable capacitors play a crucial role in the device of a wireless communication circuit, for example, elements is used in the microwave components, tunable matching network, electronic tunable filters, voltage controlled oscillators (VCOs) and so on.

In general, the design of a tunable capacitor relies on the electrostatic force to finely adjust the gap between two parallel capacitive plates in order to proportionally change the capacitance value of the tunable capacitor. The function of the tunable capacitor is to place one of the capacitive plates on a movable member and to apply the electrostatic force to drive the movable member to move toward another capacitive plate so as to change the capacitance value of the tunable capacitor. However, the movable member is usually made from an electrically insulating material, and therefore additional electrode plate is needed in order to generate the electrostatic force. Direct current (DC) input signals of the tunable capacitor are transmitted through the conversion layer. Thus, the above-mentioned function complicates the production process and cause an increase in the production cost of the tunable capacitors.

Therefore, how to simplify the structural design, to reduce the production cost and to increase the production yields of the tunable capacitors becomes a challenge to the researchers.

### SUMMARY

An embodiment of the disclosure provides a tunable capacitor comprising a substrate, at least one movable member, a first capacitive plate, a second capacitive plate, a third capacitive plate and at least one set of electrode plates, The at least one movable member is disposed on the substrate. The at least one movable member is adapted for moving away or toward the substrate to have a first position and a second position, respectively. The first capacitive plate is disposed on the at least one movable member and faces the substrate. The second capacitive plate is disposed on the substrate and faces the first capacitive plate. The third capacitive plate is disposed on the substrate and faces the first capacitive plate. The at least one set of electrode plates is disposed on the substrate and faces the at least one movable member. The set of electrode plates, driven by an electrical voltage, generates electrostatic force causing the at least one movable member to be drawn from the first position to the second position thereof to correspondingly adjust capacitance between the first capacitive plate and the second capacitive plate as well as the first capacitive plate and the third capacitive plate, respectively.

### BRIEF DESCRIPTION OF THE DRAWINGS

The disclosure will become more fully understood from the detailed description given herein below for illustration only and thus does not limit the disclosure, wherein:

FIG. 1 is a perspective view of a tunable capacitor in a first embodiment of the disclosure;

FIG. 2A is a sectional view of a movable member in FIG. 1 at a first position;

FIG. 2B is a sectional view of a movable member in FIG. 1 at a second position;

FIG. 3 is a schematic top view of a tunable capacitor in a second embodiment of the disclosure;

FIG. 4 is a schematic top view of a tunable capacitor in a third embodiment of the disclosure;

FIG. 5A is a sectional view of a tunable capacitor in a fourth embodiment of the disclosure;

FIG. 5B is a sectional view of a movable member in FIG. 5A at a second position;

FIG. 5C is a sectional view of a tunable capacitor in a fifth embodiment of the disclosure; and

FIG. 6 is a sectional view of the tunable capacitor in a sixth embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

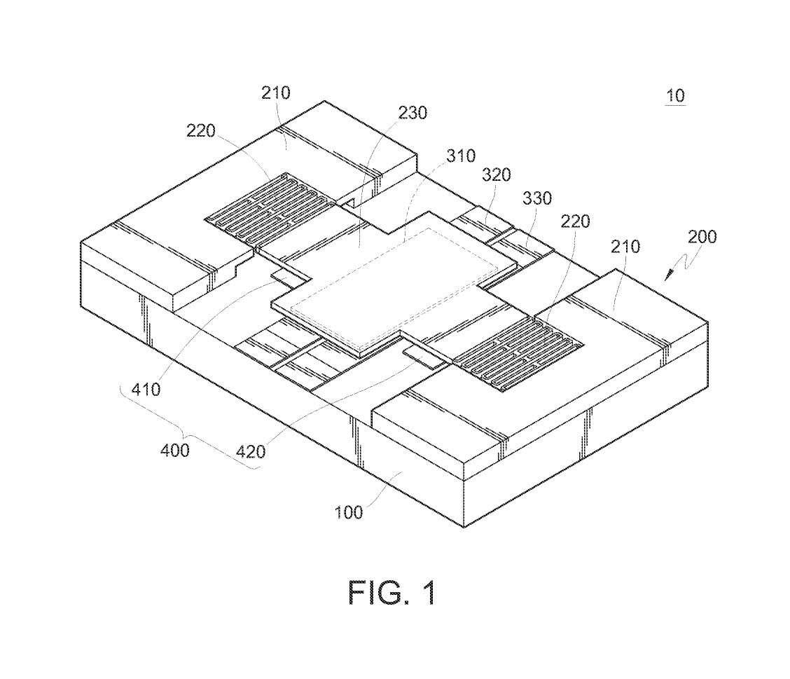

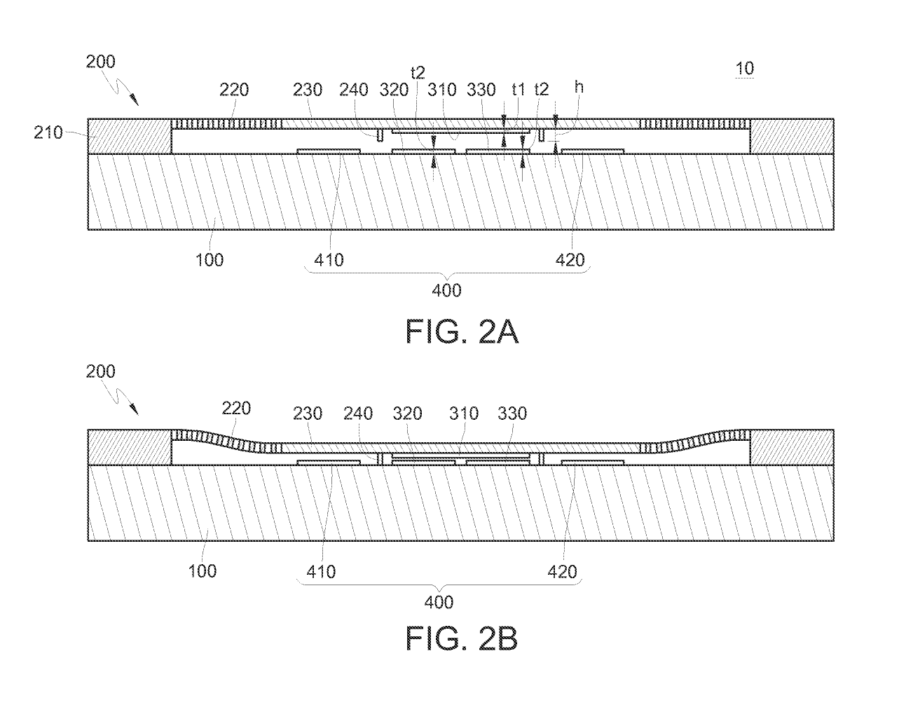

With reference to FIGS. 1 to 2B, FIG. 1 is a perspective view of a tunable capacitor in a first embodiment of the disclosure, FIG. 2A is a sectional view of a movable member in FIG. 1 at a first position, and FIG. 2B is a sectional view of a movable member in FIG. 1 at a second position.

A tunable capacitor in this embodiment comprises a substrate 100, a movable member 200, a first capacitive plate 310, a second capacitive plate 320, a third capacitive plate 330 and a set of electrode plates 400.

In this embodiment, the substrate 100 is made of an electrically insulating material, such as a glass substrate, but not limited to the disclosure. In other embodiments, the substrate 100 may be made of a non-insulating material, coated with an insulating layer thereon.

The movable member 200 is disposed on the substrate 100. The movable member 200 is adapted for moving away or closer with respect to the substrate 100 to have a first position (as shown in FIG. 2A) and a second position (as shown in FIG. 2B), respectively. Furthermore, the movable member 200 comprises two supporting portions 210, two elastic portions 220 and an attaching portion 230. The two supporting portions 210, the two elastic portions 220 and the attaching portion 230 are connected together. The attaching portion 230 is located between and connected to the two elastic portions 220. The two elastic portions 220 are connected to the two supporting portions 210, respectively. The supporting portions 210 are disposed on the substrate 100 so that the attaching portion 230 keeps a distance from the substrate 100. In addition, the two elastic portions 220 have elastic forces to cause the attaching portion 230 to flex (namely, move) in the direction away from or closer to the substrate 100.

In this embodiment and some other embodiments, the movable member 200 also comprises two protruding pieces 240 which are both attached to the attaching portion 230 and protrude toward the substrate 100. The first capacitive plate 310 is located between the two protruding pieces 240. Each of the two protruding pieces 240 has a height h. The first capacitive plate 310 has a thickness t1. Each of the second capacitive plate 320 and the third capacitive plate 330 has a thickness t2. The height h of each of the two protruding pieces 240 is taller than the total thickness t1+t2 of the first capacitive plate 310 and the second capacitive plate 320, and the first capacitive plate 310 and the third capacitive plate 330, respectively. The protruding pieces 240 in this embodiment are disposed on the movable member 200, but not limited to the disclosure. In other embodiments, the protruding pieces 240 are disposed on the substrate 100.

In this embodiment, the movable member 200 is made of a semiconductor material with high resistance. Since the movable member 200 is made of the semiconductor material, it is no need to install the electrode plate on the movable member 200, and the movable member 200 still may respond to the electrostatic force thus to move position in relative to the substrate 100. The movable member 200 has a resistivity ranging from 10³ to 10⁵ ohm-cm. When the electrical resistance of the movable member 200 is too high and the static electricity is comparatively inadequate, the moving speed of the movable member 200 is affected. Having the electrical resistance of the movable member 200 being too small may lead to the attenuation of the high frequency signal and lower the quality factor (Q value) of the movable member 200. Accordingly, the movable member 200 having a resistivity of between 10³ to 10⁵ ohm-cm is used in the embodiment in order to improve the quality factor (Q value) of the tunable capacitor 10. Moreover, the movable member 200 having the above-mentioned range of electrical resistance is not required to add electrode plates and still can be driven by the electrostatic force on the set of electrode plates 400 disposed on the substrate 100 such that the electrical capacity of the tunable capacitor 10 is adjusted. As a result, the structural design of the tunable capacitor 10 and the production complication thereof are simplified; the production cost thereof is reduced and the production yield is improved. The material of the movable member 200 is selected from a group consisting of silicon (Si), gallium arsenide (GaAs), gallium phosphide (GaP), and cadmium sulfide (CdS). The quality factor (Q value) of the capacitor is the stored energy divided by the average power dissipation in the capacitor. Therefore, the higher the quality factor is the greater efficiency of the energy storage in the capacitor becomes.

The first capacitive plate 310, disposed on the attaching portion 230 of the movable member 200, faces the substrate 100. The second capacitive plate 320, disposed on the substrate 100, faces the first capacitive plate 310. The third capacitive plate 330, disposed on the substrate 100, faces the first capacitive plate 310. The first capacitive plate 310 and the second capacitive plate 320 are electrically connected in series as well as the first capacitive plate 310 and the third capacitive plate 330 are electrically connected in series. Each of the capacitive plates 310, 320 and 330 is adapted for producing an electrical capacity when it is charged. The value of the electrical capacity is inversely proportional to the distance between the corresponding capacitive plates, and is proportional to the surface area of the corresponding capacitive plates.

In addition, the materials of the first capacitive plate 310, the second capacitive plate 320 and the third capacitive plate 330 are metals. Furthermore, the materials of the first capacitive plate 310, the second capacitive plate 320 and the third capacitive plate 330 are selected from a group consisting of gold, silver, copper, aluminum, platinum and a combination thereof, but not limited to the disclosure.

The set of electrode plates 400, disposed on the substrate 100, faces the movable member 200. The set of electrode plates 400 comprises a first electrode plate 410 and a second electrode plate 420. The second capacitive plate 320 and the third capacitive plate 330 are both located between the first electrode plate 410 and the second electrode plate 420. Due to the settings of which the first electrode plate 410 and the second electrode plate 420 as well as the second capacitive plate 320 and the third capacitive plate 330 being respectively separated and electrically insulated from one another. Therefore, the electrical signals between the electrode plates 410, 420 and the movable member 200 respectively do not interfere with one another. Furthermore, radio frequency (RF) signals between the capacitive plates 310, 320 and 330 respectively do not interfere with one another. As a result, the value of the quality factor of the tunable capacitor 10 is improved.

As illustrated in FIG. 2A, when charged and driven by the voltage, the set of electrode plates 400 generates the electrostatic force so as to draw the movable member 200 closer from the first position to the second position, and thus to adjust the capacitance between the first capacitive plate 310 and the second capacitive plate 320, as well as the first capacitive plate 310 and the third capacitive plate 330, respectively. Typically, when the movable member 200 is free from the electrostatic force generated by the set of electrode plates 400, the movable member 200 is located at the first location, and the tunable capacitor 10 has a first electrical capacity. Once the movable member 200 is attracted by the electrostatic force generated by the set of electrode plates 400 and moves toward the substrate 100, the two protruding pieces 240 on the movable member 200 bear against the substrate 100 separately so as to keep the movable member 200 at the second position. Therefore, the first capacitive plate 310 on the movable member 200 has a distance apart from both the second capacitive plate 320 and the third capacitive plate 330 on the substrate 100, respectively. Moreover, the tunable capacitor 100 has a second electrical capacity that is greater than the first electrical capacity.

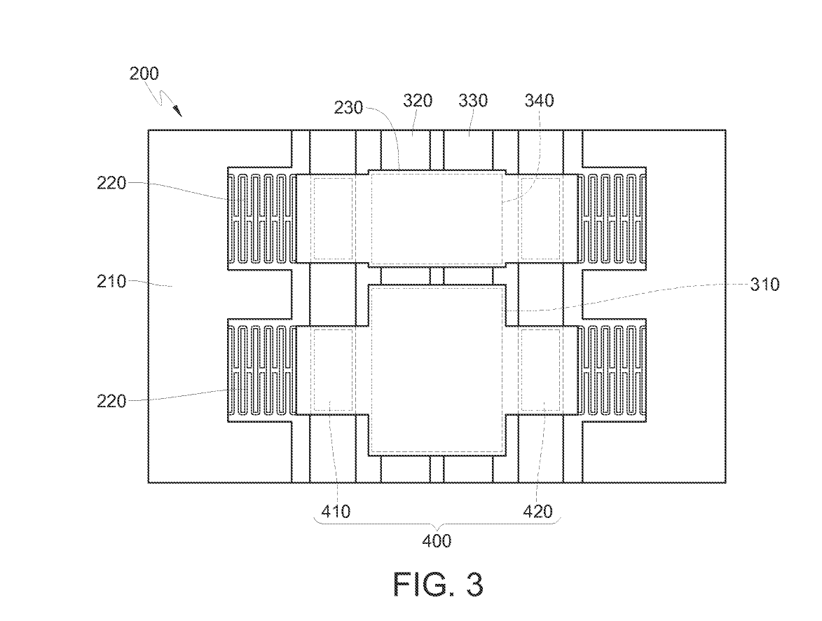

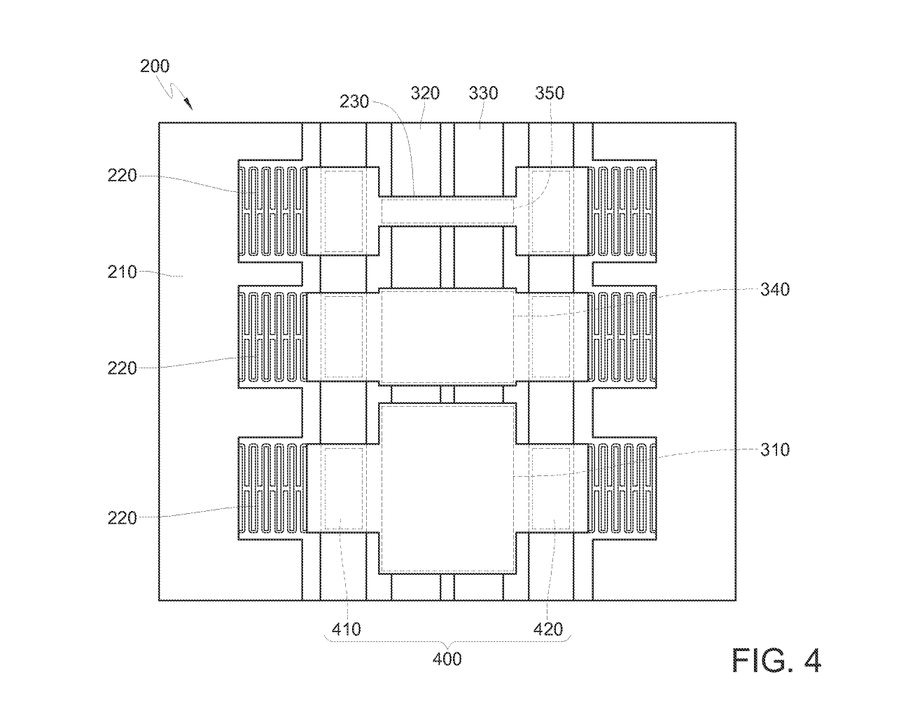

The number of the movable member 200 in the embodiment illustrated in FIG. 1 is one, but is not limited to the disclosure. In other embodiments, the number of the movable member 200 is equaled to or more than two. With reference to FIGS. 3 and 4, FIG. 3 is a schematic top view of a tunable capacitor in a second embodiment of the disclosure, and FIG. 4 is a schematic top view of a tunable capacitor in a third embodiment of the disclosure. As illustrated in FIG. 3, a tunable capacitor 10 of this embodiment includes a substrate 100, two movable members 200, a first capacitive plate 310, a second capacitive plate 320, a third capacitive plate 330, a fourth capacitive plate 340 and two sets of electrode plates 400. The two movable members 200 are movably disposed on the substrate 100 separately and are adapted for moving farther away or closer with respect to the substrate 100 to a first position or a second position, respectively. The two sets of electrode plates 400, disposed on the substrate 100 separately, face (namely, are opposite to) the two movable members 200 and are adapted for individually driving the two movable members 200 to shift (namely, move).

The first capacitive plate 310 and the fourth capacitive plate 340 are disposed separately on the attaching members 230 of the two movable members 200 and face (namely, are opposite to) the substrate 100. The second capacitive plate 320, disposed on the substrate 100, faces to the first capacitive plate 310 and the fourth capacitive plate 340. The third capacitive plate 330, disposed on the substrate 100, faces the first capacitive plate 310 and the fourth capacitive plate 340. The first capacitive plate 310 and the second capacitive plate 320, and the first capacitive plate 310 and the third capacitive plate 330 are respectively connected in series, while the fourth capacitor 340 and the second capacitive plate 320, and the fourth capacitor 340 and the third capacitive plate 330 are respectively connected in series. The areas of the sensing surface of the first capacitive plate 310 and the fourth capacitive plate 340 are different in size, so that the respective capacitance between the first capacitive plate 310 and the second capacitive plate 320, the first capacitive plate 310 and the third capacitive plate 330, the fourth capacitor 340 and the second capacitive plate 320, and the fourth capacitor 340 and the third capacitive plate 330 are individually different from each other. Therefore, the tunable capacitor 10 is adapted for producing four different values of capacitance by adjusting the two sets of electrode plates 400. In other words, electrical charges to both of the two sets of electrode plates 400, one of the two sets of electrode plates 400, or none of the two sets of electrode plates 400 may all change the electrical capacity of the tunable capacitor 10.

As illustrated in FIG. 4, a tunable capacitor 10 in this embodiment comprises a substrate 100, three movable members 200, a first capacitive plate 310, a second capacitive plate 320, a third capacitive plate 330, a fourth capacitive plate 340, a fifth capacitor 350 and three sets of electrode plates 400. The three movable members 200 are movably disposed on the substrate 100 separately and are adapted for moving farther away or closer with respect to the substrate 100 to a first position or a second position, respectively. The three sets of electrode plates 400, disposed on the substrate 100 separately, face the three movable members 200, and the three sets of electrode plates 400 are adapted for individually driving the three movable members 200 to shift.

The first capacitive plate 310, the fourth capacitive plate 340 and the fifth capacitive plate 350 are disposed separately on the attaching portion 230 of the three movable members 200 and all face the substrate 100. The second capacitive plate 320, disposed on the substrate 100, faces the first capacitive plate 310, the fourth capacitive plate 340, and the fifth capacitive plate 350. The third capacitive plate 330, disposed on the substrate 100, faces the first capacitive plate 310, the fourth capacitive plate 340, and the fifth capacitive plate 350. The first capacitive plate 310 is connected in series with the second capacitive plate 320 and the third capacitive plate 330, respectively. The fourth capacitor 340 is connected in series with the second capacitive plate 320 and the third capacitive plate 330, respectively. The fifth capacitor 350 is connected in series with the second capacitive plate 320 and the third capacitive plate 330, respectively. The areas of the sensing surface of the first capacitive plate 310, the fourth capacitive plate 340, and the fifth capacitive plate 350 are different from one another, leading to the capacitance between the first capacitive plate 310 and the second capacitive plate 320, the first capacitive plate 310 and the third capacitive plate 330, the fourth capacitor 340 and the second capacitive plate 320, the fourth capacitor 340 and the third capacitive plate 330, the fifth capacitor 350 and the second capacitive plate 320, and the fifth capacitor 350 and the third capacitive plate 330 being different from one another. Therefore, the tunable capacitor 10 may produce eight different values of capacitance by adjusting the three sets of electrode plates 400. In other words, the more movable members 200 and sets of electrode plates 400 are used, the more different values of electrical capacity may be produced by the tunable capacitor 10, thus to increase the fine resolution of capacitance of the tunable capacitor 10.

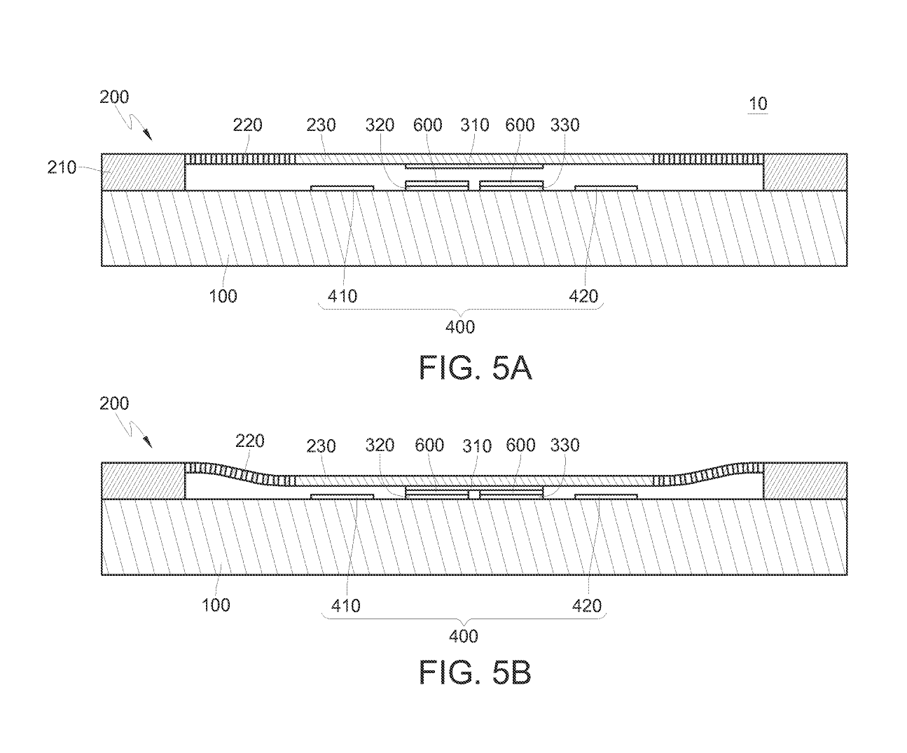

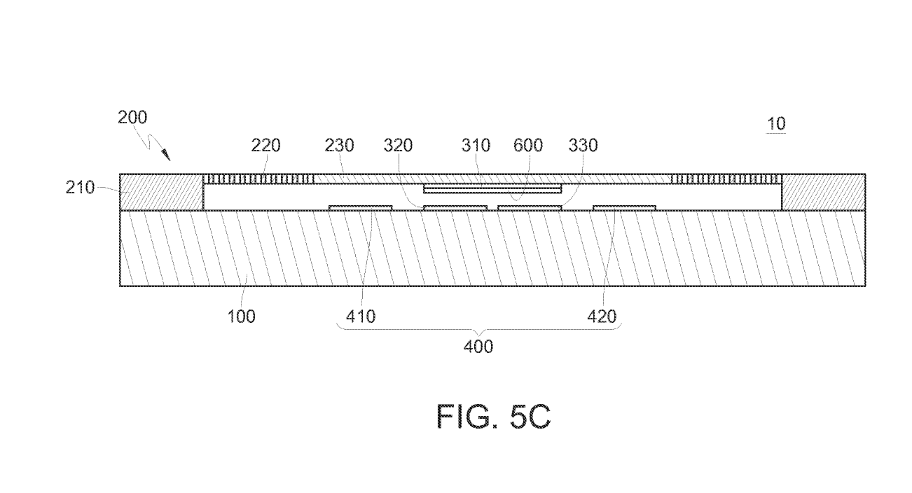

With reference to FIGS. 5A and 5B, FIG. 5A is a sectional view of a tunable capacitor in a fourth embodiment of the disclosure, and FIG. 5B is a sectional view of a movable member in FIG. 5A at a second position. Since the embodiment shown in FIG. 5A is similar to that in FIG. 1, explanations are given on the differences only.

As shown in FIG. 5A, a tunable capacitor 10 in this embodiment comprises a substrate 100, a movable member 200, a first capacitive plate 310, a second capacitive plate 320, a third capacitive plate 330, two insulating layers 600 and a set of electrode plates 400. The movable member 200 is movably disposed on the substrate 100 and is adapted for moving farther away or closer with respect to the substrate 100 to a first position (as shown in FIG. 5A) or a second position (as shown in FIG. 5B), respectively. The first capacitive plate 310, disposed on the movable member 200, face (namely, is opposite to) the substrate 100. The second capacitive plate 320 and the third capacitive plate 330, both disposed on the substrate 100, face the first capacitive plate 310, respectively. The two insulating layers 600 are disposed on the second capacitive plate 320 and the third capacitive plate 330 separately, and both face to the first capacitive plate 310. The material of the insulating layer 600 is selected from a group consisting of silicon dioxide and silicon nitride and a combination thereof. The set of electrode plates 400 is disposed on the substrate 100 and faces (namely, is opposite to) the movable member 200.

As shown in FIG. 5B, when charged by the voltage to generate the electrostatic force, the set of electrode plates 400 draws the movable member 200 closer from the first position to the second position such that the first capacitive plate 310 on the movable member 200 bears (namely, abuts) against the insulating layers, keeping the first capacitive plate 310 and the second capacitive plate 320, and the first capacitive plate 310 and the third capacitive plate 330 respectively at a distance apart in order to adjust the capacitance between the first capacitive plate 310 and the second capacitive plate 320, and the first capacitive plate 310 and the third capacitive plate 330, respectively.

However, the number and location of the insulating layer 600 are not intended to limit the disclosure. Please refer to FIG. 5C, which is a sectional view of a tunable capacitor in a fifth embodiment. Since the embodiment shown in FIG. 5A is similar to that in FIG. 5B, explanations are given on the differences only. The number of the insulating layer 600 in the tunable capacitor 10 in this embodiment is one and the insulating layer 600, disposed on the first capacitive plate 310, face the second capacitive plate 320 and the third capacitive plate 330, respectively.

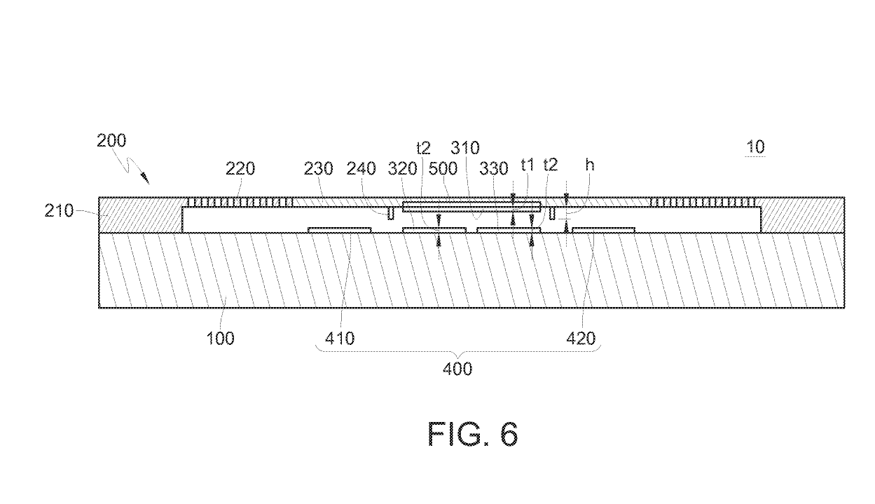

With reference to FIG. 6, FIG. 6 is a sectional view of a tunable capacitor in a sixth embodiment of the disclosure. A tunable capacitor 10 in this embodiment comprises a substrate 100, a movable member 200, an intermediate layer 500, a first capacitive plate 310, a second capacitive plate 320, a third capacitive plate 330 and a set of electrode plates 400. In this embodiment, the substrate 100 is made of an insulating material, such as a glass substrate, but not limited to the disclosure. In other embodiments, the substrate 100 is made of a non-insulating material, coated with an insulating layer thereon. The movable member 200 is movably disposed on the substrate 100. The movable member 200 is adapted for moving farther away or closer with respect to the substrate 100 to a first position or a second position, respectively. Furthermore, the movable member 200 comprises two supporting portions 210, two elastic portions 220 and an attaching portion 230 that are connected together. The attaching portion 230 is located between and connected to the two elastic portions 220. The two elastic portions 220 are connected to the two supporting portions 210, respectively. The supporting portions 210 are disposed on the substrate 100 so that the attaching portion 230 keeps a distance apart from the substrate 100. In addition, the elastic forces of the two elastic portions 220 cause the attaching portion 230 to flex (namely, move) in the direction farther away from or closer to the substrate 100.

In this embodiment and some other embodiments, the movable member 200 also comprises two protruding pieces 240 which are attached to the attaching portion 230 and protrude toward the substrate 100. The first capacitive plate 310 is located between the two protruding pieces 240. Each of the two protruding pieces 240 has a height h. The first capacitive plate 310 has a thickness t1. Each of the second capacitive plate 320 and the third capacitive plate 330 has a thickness t2. The height h of each of the two protruding pieces 240 is taller than the total thickness t1+t2 of the first capacitive plate 310 and the second capacitive plate 320, and the first capacitive plate 310 and the third capacitive plate 330, respectively.

In this embodiment, the movable member 200 is made of a conductive material. Since the movable member 200 is made of a conductive material, the movable member 200 is not required to install additional electrode plates and still can be drawn by the electrostatic force to move with respect to the substrate 100 accordingly. The intermediate layer 500, disposed on the attaching portion 230, faces the substrate 100. The intermediate layer 500 is made of a high resistance semiconductor material.

The first capacitive plate 310, disposed on the intermediate layer 500, faces the substrate plate 100. The second capacitive plate 320, disposed on the substrate 100, faces the first capacitive plate 310. The third capacitive plate 330, disposed on the substrate 100, faces the first capacitive plate 310. The first capacitive plate 310 and the second capacitive plate 320 are electrically connected in series. Also, the first capacitive plate 310 and the third capacitive plate 330 are electrically connected in series. Each of the capacitive plates 310, 320 and 330 are adapted for producing an electrical capacity when it is charged. The value of the electrical capacity is inversely proportional to the distance between the corresponding capacitive plates, and is proportional to the surface area of the corresponding capacitive plates.

The set of electrode plates 400 is disposed on the substrate 100 and faces the movable member 200. The set of electrode plates 400 comprises a first electrode plate 410 and a second electrode plate 420. The second capacitive plate 320 and the third capacitive plate 330 are both located between the first electrode plate 410 and the second electrode plate 420. Due to the settings of which the first electrode plate 410 and the second electrode plate 420 as well as the second capacitive plate 320 and the third capacitive plate 330 are respectively separated and electrically insulated from one another, the electrical signals between the electrode plates 410, 420 and the movable member 200 respectively as well as the RF signals between the capacitive plates respectively do not interfere with one another. As a result, the value of the quality factor of the tunable capacitor 10 is enhanced.

When charged by the voltage to generate the electrostatic force, the set of electrode plates 400 draws the movable member 200 closer from the first position to the second position thus to adjust the electrical capacity between the first capacitive plate 310 and the second capacitive plate 320, as well as the electrical capacity between the first capacitive plate 310 and the third capacitive plate 330. When the movable member 200 is free from the electrostatic force posed by the set of electrode plates 400, the movable member 200 is located at the first location, and at this time, the tunable capacitor 10 has a first electrical capacity. Once the movable member 200 is attracted by the electrostatic force posed by the set of electrode plates 400 and moves toward the substrate 100, the two protruding pieces 240 on the movable member 200 bear against the substrate 100 separately to keep the movable member 200 at the second position. The first capacitive plate 310 on the movable member 200 is kept at a distance apart from both the second capacitive plate 320 and the third capacitive plate 330 on the substrate 100 respectively. At this time, the tunable capacitor 100 has a second electrical capacity that is greater than the first electrical capacity.

According to the tunable capacitor of the disclosure described above, the movable member is made from a high resistance semiconductor material and the movable member has a resistivity ranging from 10³ to 10⁵ ohm-cm. Within the specified range of the electrical resistance, the movable members are not required to install additional electrode plates and still can be drawn by the electrostatic force from the set of electrode plates disposed on the substrate so as to adjust the electrical capacity of the tunable capacitor accordingly. As a result, the structural design of the tunable capacitor and the production complication thereof are simplified, leading to reduction in production cost and increase in production yields.

Furthermore, the first electrode plate and the second electrode plate as well as the second capacitive plate and the third capacitive plate are separated and electrically isolated from one another. The electrical signals between the electrode plates and the movable member as well as signals between capacitive plates do not interfere with one another. As a result, the value of the quality factor of the tunable capacitors is improved.

What is claimed is:

1. A tunable capacitor, comprising:
a substrate;
at least one movable member disposed on the substrate, wherein the at least one movable member is adapted for moving away or toward the substrate to have a first position and a second position, respectively;
a first capacitive plate disposed on the at least one movable member and facing the substrate;
a second capacitive plate disposed on the substrate and facing the first capacitive plate;
a third capacitive plate disposed on the substrate and facing the first capacitive plate; and
at least one set of electrode plates disposed on the substrate and facing the at least one movable member, wherein the set of electrode plates, driven by an electrical voltage, generates electrostatic force causing the at least one movable member to be drawn from the first position to the second position thereof to correspondingly adjust capacitance between the first capacitive plate and the second capacitive plate as well as the first capacitive plate and the third capacitive plate, respectively.

2. The tunable capacitor according to claim 1, wherein the at least one movable member has a resistivity ranging from 10³ to 10⁵ ohm-cm.

3. The tunable capacitor according to claim 1, wherein the set of electrode plates includes a first electrode plate and a second electrode plate, and the second capacitive plate and the third capacitive plate are disposed between the first electrode plate and the second electrode plate.

4. The tunable capacitor according to claim 1, wherein the at least one movable member includes two supporting portions, two elastic portions and an attaching portion that are connected together, the attaching portion is located between and is connected to the two elastic portions, the two elastic portions are connected to the two supporting portions respectively, and the first capacitive plate is disposed on the attaching portion.

5. The tunable capacitor according to claim 4, wherein the at least one movable member includes two protruding pieces attached to the attaching portion and protruding toward the substrate, the first capacitive plate is located between the two protruding pieces, the height of each of the two protruding pieces is taller than a total thickness of the first capacitive plate and the second capacitive plate, and the first capacitive plate and the third capacitive plate, respectively, and wherein, when the at least one movable member is at the second position, the two protruding pieces bear against the substrate separately to keep the first capacitive plate at a distance apart from both of the second capacitive plate and the third capacitive plate respectively.

6. The tunable capacitor according to claim 1, wherein the substrate is made of an electrically insulating material.

7. The tunable capacitor according to claim 1, wherein the material of the at least one movable member is selected from a group consisting of silicon, gallium arsenide, gallium phosphide and cadmium sulfide.

8. The tunable capacitor according to claim 1, wherein the materials of the first capacitive plate, the second capacitive plate and the third capacitive plate are metals.

9. The tunable capacitor according to claim 1, further comprising at least one insulating layer, and wherein the at least one insulating layer is disposed on the first capacitive plate and faces the second capacitive plate and the third capacitive plate.

10. The tunable capacitor according to claim 1, further comprising two insulating layers, and wherein the two insulating layers are disposed on the second capacitive plate and the third capacitive plate separately, and the two insulating layers face to the first capacitive plate.

11. The tunable capacitor according to claim 1, further comprising a fourth capacitive plate, wherein the number of the at least one movable members is two, the number of the at least one set of electrode plates is two, the first capacitive plate and the fourth capacitive plate are disposed on the two movable members, respectively, and both of the first capacitive plate and the fourth capacitive plate face the second capacitive plate and the third capacitive plate, and wherein the two sets of electrode plates, driven by the electrical voltage respectively, generate electrostatic forces separately causing the two movable members to be drawn from the first position to the second position individually thereof to correspondingly adjust the capacitance between the first capacitive plate and the second capacitive plate, the first capacitive plate and the third capacitive plate, the fourth capacitive plate and the second capacitive plate, and the fourth capacitive plate and the third capacitive plate, respectively.

12. The tunable capacitor according to claim 1, further comprising a fourth capacitive plate and a fifth capacitive plate, wherein the number of the at least one movable members is three; the number of the at least one set of electrode plates is three, the first capacitive plate, the fourth capacitive plate and the fifth capacitive plate are disposed on the three movable members respectively and all face the second capacitive plate and the third capacitive plate, and wherein the three sets of electrode plates, driven by the electrical voltage respectively, generate electrostatic forces separately causing the three movable members to be drawn from the first position to the second position individually thereof to correspondingly adjust the capacitance between the first capacitive plate and the second capacitive plate, the first capacitive plate and the third capacitive plate, the fourth capacitive plate and the second capacitive plate, the fourth capacitive plate and the third capacitive plate, the fifth capacitive plate and the second capacitive plate, and the fifth capacitive plate and the third capacitive plate, respectively.
